(19) United States
(12) Patent Application Publication
(10) Pub. No.: US 2026/0064402 A1
(43) Pub. Date: Mar. 5, 2026

(54) NEAR-ZERO DOWNTIME MAINTENANCE OF THE EDGE LAYER IN CLOUD DATABASES

(71) Applicant: SAP SE, Walldorf (DE)

(72) Inventors: Henrik Hempelmann, Hansestadt Havelberg (DE); Dan Jia, Berlin (DE); Jakob Kraess, Berlin (DE); Asif Hasnain, Paderborn (DE); Saiful Hoque, Berlin (DE); Teodora Ivanova Ilieva, Plovdiv (BG)

(73) Assignee: SAP SE, Walldorf (DE)

(21) Appl. No.: 18/820,084

(22) Filed: Aug. 29, 2024

(51) Int. Cl. G06F 8/656

(52) U.S. Cl. CPC G06F 8/656

(57) ABSTRACT

Near-zero downtime maintenance of containerized applications can be achieved via a modified rolling update strategy for a container orchestration platform. During deployment of a first set of containers based on a first deployment that specifies an image of a first software version and a grace period for preserving existing connections to the first set of containers, a second deployment object is received that specifies an image of a second software version and a minimum execution time for a second set of containers after which new connections to the second set of containers are allowed. After deployment of the second set of containers, new connections to the second set of containers are not enabled until the respective containers have executed for the minimum execution time. Existing connections to each container of the first set of containers are preserved until the earlier of their completion or expiration of the grace period.

### FIELD

The field generally relates to edge layer maintenance for cloud databases that employ container orchestration platforms.

### BACKGROUND

Container orchestration platforms are often used to automate deployment, scaling, and maintenance of containerized applications. One such container orchestration platform is the KUBERNETES™ framework, developed and maintained by The Linux Foundation. While KUBERNETES is often used in the context of stateless web services without persistent connections, it can also be employed in stateful applications such as cloud databases.

Attempts have been made employ KUBERNETES to orchestrate edge layer maintenance for cloud databases. For example, when a new software version is released for containerized applications which perform edge layer functionality in a cloud database, KUBERNETES can perform rolling updates to pods that host the containerized applications.

The standard procedure for performing rolling updates via KUBERNETES involves dropping the active instances of the pods, one by one, and replacing them with new pods. While such operation may be acceptable in a stateless application where connections are typically short-lived, the same is not true for stateful applications with longer-lived connections. For example, if a connection between a client application and a database is dropped, the client application may receive an error and have to redo the last database operation. This can result in the loss of several hours of computation time. Consequently, using standard KUBERNETES rolling update procedures for cloud databases may yield undesirable outcomes.

### BRIEF DESCRIPTION OF THE DRAWINGS

FIG. 1 is a block diagram of an example container orchestration platform.

FIG. 2 is a block diagram of an example system implementing near-zero downtime maintenance of the edge layer for a cloud database.

FIGS. 3-4 depict a sequence diagram of a process for updating a reverse proxy using a modified rolling update procedure.

FIGS. 5-8 are block diagrams of various stages of a modified rolling update procedure for a reverse proxy.

FIG. 9 is a flowchart of an example method of updating containers using a modified rolling update procedure.

FIG. 10 is a flowchart of an example method of stopping a container in accordance with a modified rolling update procedure.

FIG. 11 is a block diagram of an example computing system in which described embodiments can be implemented.

FIG. 12 is a block diagram of an example cloud computing environment that can be used in conjunction with the technologies described herein.

### DETAILED DESCRIPTION

### Example 1—Overview

In a cloud database employing a container orchestration platform, maintenance of containerized applications can be performed via a modified rolling update strategy in accordance with techniques described herein. The containerized applications can include containers executing software providing edge layer functionality for a cloud database. Strategic modifications are made to a standard rolling update procedure to reduce disruption of relatively long-lived database connections, while still employing standard container orchestration platform practices such that no additional operator or workflow is required to enact an update to containerized applications.

For example, a first set of containers may be deployed in a container orchestration platform based on a first deployment object that specifies an image of a first software version. The first software version can be a first version of edge layer software, for example. The contents of the first deployment object can be selected to reduce potential disruption of database connections. For example, values of certain fields in the first deployment object can be set within predetermined ranges that have been determined to reduce potential disruption of database connections.

Towards this end, the first deployment object can include a field which specifies a grace period for preserving existing connections to the first set of containers after the first set of containers have been terminated (e.g., after the first set of containers have received a stop signal). The field which specifies the grace period can be assigned a value within a specified range (e.g., one or more days). The value of the grace period may be different than typical values used in deployment objects in this context. The first deployment object can also include a field which specifies a minimum execution time for the first set of containers. The minimum execution time field can be assigned a value within a specified range (e.g., a few minutes). The values of the minimum execution time and grace period may be different than typical values used in deployment objects in this context.

When it is time to update the first software version, a second deployment object that specifies an image of a second software version is received (e.g., an updated version of the edge layer software). The contents of the second deployment object can also be selected to reduce potential disruption of database connections, and can be similar to those of the first deployment object. For example, a field of the updated deployment which specifies a minimum execution time for a second set of containers can be assigned a value within a specified range (e.g., a few minutes), whereas a field specifying a grace period for preserving existing connections to the second set of containers can be assigned a value within another specified range (e.g., one or more days). In some examples, the values of the minimum execution time and grace period fields may be the same among the deployment objects for an original software version and subsequent updated versions of the software (e.g., a first software version, a second software version that is an updated version of the first software version, a third software version that is an updated version of the second software version, and so on). In other examples, however, the values of one or more parameters may differ among the deployment objects for the different software versions.

The second set of containers can be deployed in the container orchestration platform based on the second deployment object. After the second set of containers have executed for the minimum execution time specified in the second deployment object, new connections to the second set of containers are enabled and new connections to the first set of containers are disabled. The new connections may be new cloud database connections, for example. After the second set of containers are made available for connections, existing connections (e.g., existing cloud database connections) are still handled by the first set of containers, whereas new connections are routed to the second set of containers instead of the first set of containers. Termination of the first set of containers is initiated, but is not carried out until certain criteria are met. In particular, for a given container of the first set of containers, the given container is stopped responsive to the earlier of completion of all existing connections to the given container and expiration of the grace period specified in the first deployment object. For example, if an existing connection to a given container of the first set of containers completes prior to expiration of the grace period, the given container is stopped prior to expiration of the grace period. However, if the given container still has an existing connection at the time the grace period expires, the existing connection is forcefully terminated.

The following Examples describe how disclosed techniques can be implemented in the specific embodiment of a computing environment employing KUBERNETES. However, disclosed technologies can be used with other container orchestration platforms, or in other environments.

### Example 2—Example Container Orchestration Platform

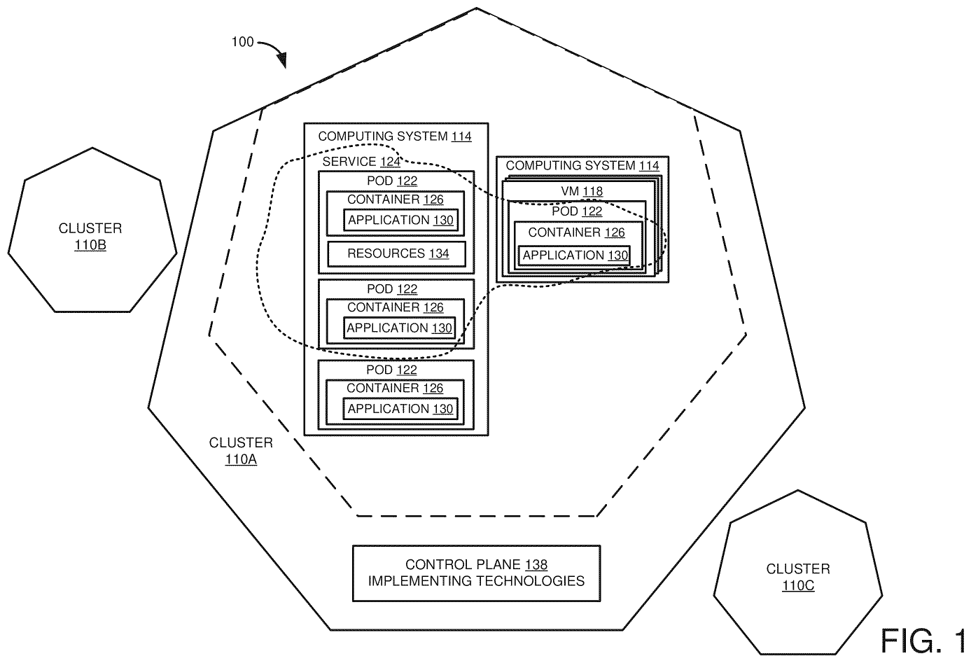

FIG. 1 illustrates an example container orchestration platform 100 in which disclosed technologies can be implemented. In particular, container orchestration platform 100 is a computing environment in which a software program such as KUBERNETES can automate deployment, scaling, and maintenance of containerized software applications.

The container orchestration platform 100 includes a plurality of computing clusters 110, shown as clusters 110a-110c. In practice, any number of computing clusters 110 may be included in the container orchestration platform 100. In the example, cluster 110a shows details of components that can be included in the clusters 110. As shown, the cluster 110a includes a plurality of computing systems 114, which may alternatively be referred to as nodes. At least a portion of the computing systems 114 include one or more virtual machines (VMs) 118.

A computing system 114, or a VM 118 running within a computing system, hosts one or more pods 122, where a given pod can in turn host one or more applications 130 running inside a respective container 126. At least a portion of the pods 122 can include resources 134, such as having all or a portion of a storage volume assigned to the pod. One or more pods 122 can be combined into a service 124, where the pods in a service can be located on the same computing system 114 or on different computing systems.

A cluster 110 can be managed by a control plane 138. The control plane 138 can provide an Application Programming Interface (API) for interacting with the cluster 110 and its constituent components. Towards this end, the control plane 138 can include an API server, among other components. As described herein, the control plane 138 can implement innovations for near-zero downtime maintenance of the edge layer in a cloud database (e.g., in conjunction with other components of the container orchestration platform 100).

In the KUBERNETES framework, a given cluster 110 can include a plurality of replica sets, where each replica set is a controller object that manages a set of identical pods 122. The replica sets are managed by objects referred to as deployments which provide declarative updates for pods and replica sets. Towards this end, each deployment includes a plurality of fields which describe a desired state of the associated replica set, as described further herein. The deployments are typically formatted as YAML Ain′t Markup Language (YAML) objects or JavaScript Object Notation (JSON) objects.

Various approaches are used in KUBERNETES to update containerized applications hosted on pod. One such approach is the rolling update strategy described above, in which an update to a deployment for an existing replica set triggers generation of a new replica set which ultimately replaces the existing replica set. As described further herein, the standard rolling update strategy used in KUBERNETES can be modified to reduce downtime of the components being updated.

### Example 3—Example System Implementing Near-Zero Downtime Maintenance of the Edge Layer in a Cloud-Based Database

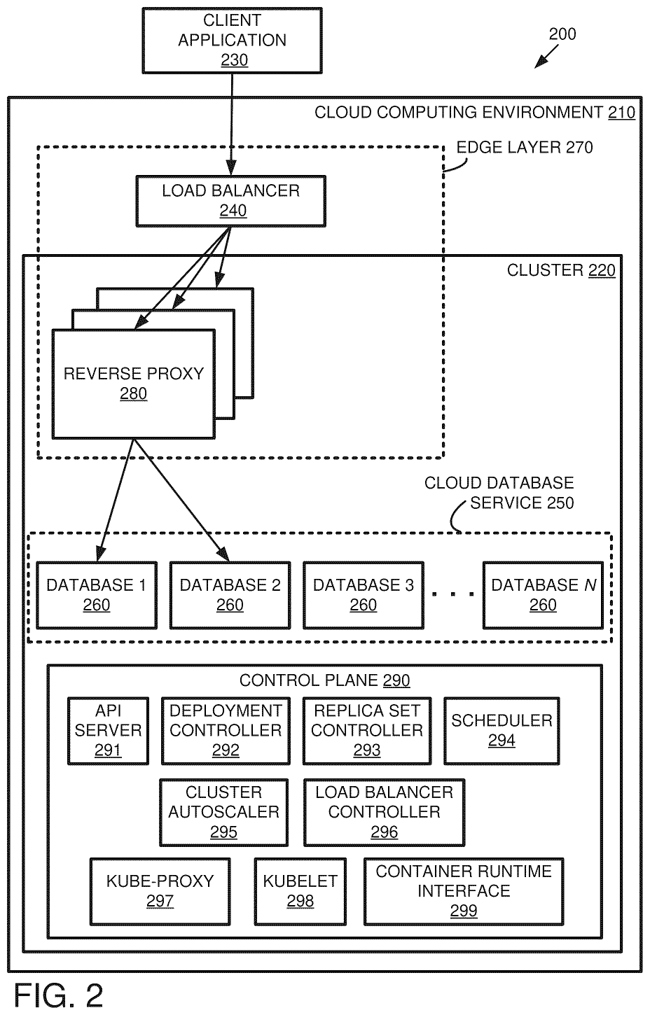

FIG. 2 is a block diagram of an example system 200 implementing near-zero downtime maintenance of the edge layer in a cloud-based database. In the example, the system 200 includes a cloud computing environment 210 in which a cluster 220 of a container orchestration platform (e.g., a KUBERNETES cluster) automates deployment, scaling, and maintenance of containerized software applications. Cluster 220 can include features similar to those described above for cluster 110a of FIG. 1. As shown, a client application 230 communicates with internal components of cloud computing environment 210 via a load balancer 240 of the cloud computing environment 210. While a single client application 230 is depicted in the example, numerous client applications 230 may communicate with internal components of the cloud computing environment 210 in practice. Cloud computing environment 210 can be built on a hyperscaler architecture employed by a large-scale cloud service provider to provide flexible, scalable resources to customers of cloud services.

In the example, the cluster 220 implements a cloud database service 250 comprising a plurality of databases 260. Cloud database service 250, which is alternatively referred to herein simply as a cloud database, can be implemented in the manner described above with reference to service 124 of FIG. 1. Accordingly, cloud database service 250 can include a plurality of pods (e.g., pods 122 of FIG. 1) which are located on the same computing system or on different computing systems. Among other functionality, the pods of cloud database service 250 implement a plurality of databases 260 include databases 1 . . . N, where N is any positive integer. Each database 260 can include one or more pods.

An edge layer 270 of the cloud computing environment 210 serves to protect internal cloud components, such as databases 260, from unauthorized access. For example, the edge layer 270 can route legitimate connections from client applications (e.g., client application 230) to databases 260 via the load balancer 240 and a reverse proxy 280. The load balancer 240 acts as an external client-facing endpoint into the cloud computing environment 210 and provides load balancing functionality. In a hyperscaler context, the load balancer 240 can be implemented by software (e.g., software associated with the large-scale cloud service provider). In the example, the load balancer 240 is external to the cluster 220 (e.g., it is not implemented via a container orchestration platform such as KUBERNETES). However, in other examples, some or all of the functionality of the load balancer 240 may be performed by components of the cluster 220.

The reverse proxy 280 of edge layer 270 is implemented as a separate set of pods within the cluster 220, sometimes referred to as a replica set. The reverse proxy 280 acts as an intermediary between external clients (e.g., client application 230) and the cloud database service 250. In particular, the reverse proxy 280 routes connections from external clients to the databases 260 and provides additional services such as load balancing and security services. In some examples, the reverse proxy 280 is implemented by high availability proxy software such as the open source HAProxy product (available at https://www.haproxy.org).

In practice, when a customer of the cloud database service 250 wishes to establish a connection to one of the databases 260, the client application 230 transmits a connection request to the load balancer 240 (e.g., a Structured Query Language (SQL) request). The load balancer 240 routes the request transparently to the reverse proxy 280 (and thus, to one of the reverse proxy pods). In some examples, the load balancer 240 routes the request in a “round robin” manner (e.g., in a circular, sequential order). The reverse proxy pod then routes the request to the specified one of the databases 260. In the example, the arrows leading from the reverse proxy pods to database 1 and database 2 represent two example database connections established in this manner.

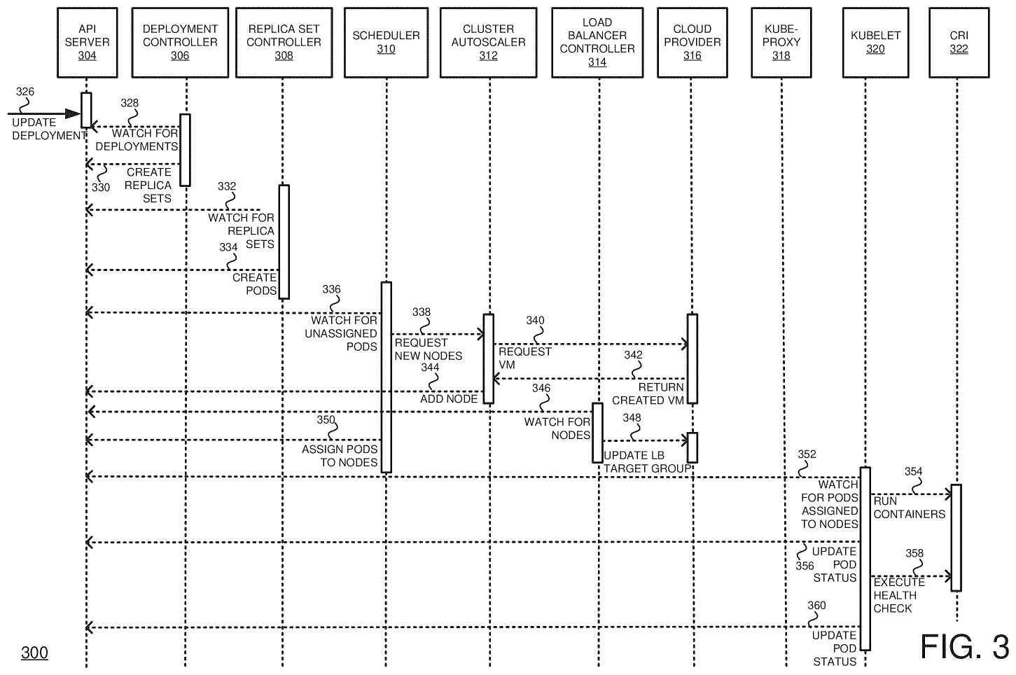

Cluster 220 includes a control plane 290, which corresponds to control plane 138 of FIG. 1. In the example, the control plane 290 includes an API server 291, a deployment controller 292, a replica set controller 293, a scheduler 294, a cluster autoscaler 295, a load balancer controller 296, a kube-proxy 297, a kubelet 298, and a container runtime interface (CRI) 299. The control plane 290 can alternatively include different components (e.g., fewer or more components and/or different types of components) than those depicted in FIG. 2. While some KUBERNETES-specific components are depicted (e.g., kube-proxy 297 and kubelet 298), other components which provide similar functionality can be substituted in examples where a different container orchestration platform is used. The functionality of control plane 290 is described in further detail below with reference to FIG. 3.

Any of the systems herein, including the system 200, can comprise at least one hardware processor and at least one memory coupled to the at least one hardware processor.

The system 200 can also comprise one or more non-transitory computer-readable media having stored therein computer-executable instructions that, when executed by the computing system, cause the computing system to perform any of the methods described herein.

In practice, the systems shown herein, such as system 200, can vary in complexity, with additional functionality, more complex components, and the like. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 200 and any of the other systems described herein can be implemented in conjunction with any of the hardware components described herein, such as the computing systems described below (e.g., processing units, memory, and the like). In any of the examples herein, computer-readable media associated with the various modules of the control plane 290, the databases 260, and the like can be stored in one or more computer-readable storage media or computer-readable storage devices. The technologies described herein can be generic to the specifics of operating systems or hardware and can be applied in any variety of environments to take advantage of the described features.

### Example 4—Example Modified Rolling Update Process for Updating a Reverse Proxy

Container orchestration platforms such as KUBERNETES can facilitate maintenance of components in a cloud computing environment. For example, KUBERNETES can orchestrate rolling updates of pods hosting containerized applications when a new software version is released.

As described above, the standard procedure for performing rolling updates via KUBERNETES involves dropping the active instances of the pods, one by one, and replacing them with new pods. However, such operation can be problematic in the context of a cloud database service with relatively long-lived database connections, especially during updates to edge layer components. Accordingly, techniques are described herein for performing a modified rolling update procedure to achieve near-zero downtime during maintenance of the edge layer.

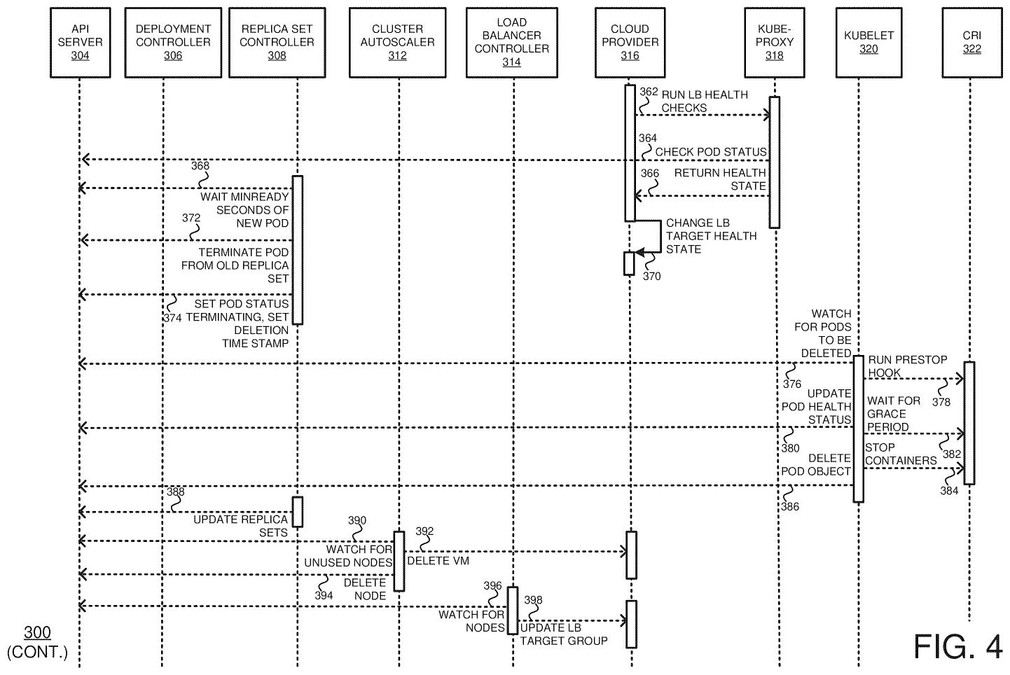

FIGS. 3-4 collectively form a sequence diagram of an example process 300 for updating a reverse proxy using a modified rolling update procedure and can be performed, for example, by the system of FIG. 2 (e.g., by a KUBERNETES cluster such as cluster 220 of FIG. 2). In particular, process 300 illustrates operations occurring in a container orchestration platform cluster implemented in a cloud computing environment (e.g., a hyperscaler environment) hosted by a cloud provider 316. As shown, the actors involved in the process 300 include the cloud provider 316 as well as by components of a container orchestration platform control plane including an API server 304, a deployment controller 306, a replica set controller 308, a scheduler 310, a cluster autoscaler 312, a load balancer controller 314, a kube-proxy 318, a kubelet 320, and a CRI 322. The columns associated with each of the actors represent execution threads of associated software. Some KUBERNETES-specific components are depicted (e.g., kube-proxy 318 and kubelet 320) for ease of explanation; in examples where a different container orchestration platform is used, other components which provide similar functionality can be substituted.

In the example, at 326, an updated deployment is received at API server 304. The updated deployment can be formatted as a deployment object (e.g., a .yam1 or JSON object) containing a specification for a replica set. The specification can include a pod template specification with fields such as a node selector field whose value can be set to constrain which nodes a pod will be scheduled on based on node labels.

At 328, the deployment controller 306 watches (e.g., monitors) the API server 304 for deployments. After detecting the updated deployment, the deployment controller 306 sends a request to the API server 304 at 330 for creation of a new replica set based on the updated deployment. In the depicted example, the new replica is to be an updated version of an existing replica set, also referred to herein as an old replica set; accordingly, the updated deployment can be understood as an updated version of a deployment that was previously used to create the old replica set. While creation of a single new replica set is described in the example for the sake of simplicity, multiple replica sets may alternatively be created at this stage.

As shown, the replica set controller 308 monitors the API server 304 for request to create replica sets at 332. After detecting the request for creation of the new replica set, the replica set controller 308 sends a request to the API server for creation of pods for the new replica set at 334. Meanwhile, at 336, the scheduler 310 monitors the API server to watch for unassigned pods.

After detecting the newly created pods, the scheduler 310 requests new nodes from the cluster autoscaler 312 at 338, in order to schedule each pod onto a node. In the example, the updated deployment pertains to a replica set for a reverse proxy component, and thus the node selector field in the pod template specification of the updated deployment specifies that the node onto which each pod is scheduled should belong to the class “edge.” Typically, there is no idle edge node available in the cluster that can handle the scheduled workload. Accordingly, at this stage, the cluster autoscaler 312 detects a demand for another worker node and requests a new VM from the cloud provider 316 at 340.

After the cloud provider 316 returns the created VM at 342, the cluster autoscaler 312 adds the new node (e.g., creates the new node in the cluster) at 344. As shown, the load balancer controller 314 watches the API server 304 to monitor for new nodes at 346; after detecting the new node, the load balancer controller 314 updates a load balancer target group at 348 in order to register the new node as a target in the target group of the load balancer (e.g., the load balancer of the cloud provider 316).

After the registration, the target has an initial status until a specified number of health checks have been sent. Depending on the response to the health checks, the status becomes either healthy or unhealthy. The load balancer is typically configured to only balance traffic over healthy targets in a round robin manner. If there are only unhealthy targets available, the load balancer operates in a fail-open mode and balances over all targets.

After the node becomes ready, the scheduler 310 sends a request to the API server 304 to assign a pod to the new node at 350. The kubelet 320, which watches the API server 304 at 352 to monitor for pods assigned to nodes, detects the pod, and transmits a request to the CRI 322 at 354 to run containers on the pod. In other words, the kubelet 320 instructs the CRI 322 to create and start containers based on the pod specification for the pod. This can include pulling container images, setting up networking, and applying resource constraints. The kubelet 320 then sends a request to the API server 304 to update the pod status at 356.

Next, the kubelet 320 instructs the CRI 322 to execute a health check at 358 to determine whether the containers are running correctly and ready to serve traffic. In this case, the definition of ready is that the reverse proxy implemented by the pods is able to handle traffic and serve connections. In some examples, a readiness probe configured in the specification of the pod sends a HyperText Transfer Protocol (HTTP) request to a health check endpoint of the pod (referred to as a healthz endpoint in KUBERNETES) to execute the health check. In this case, the health check endpoint is exposed on a separate port and is handled by the pod itself. After the readiness probe receives a response with HTTP status code 200 from the health check endpoint, it is understood that the pod is up and running and serving the sockets to which it listens. In other words, the pod is ready to handle traffic at this stage. After the health check is executed, the kubelet 320 instructs the API server 304 to update the pod status at 360.

Process 300 continues in FIG. 4. At 362, the cloud provider 316 sends a request to kube-proxy 318 to run load balancer health checks. In KUBERNETES, load balancer health checks may be sent to a port named healthCheckNodePort which is backed by kube-proxy 318, or alternatively by a container network interface (not shown) such as Cilium or Calico. In the example, kube-proxy 318 checks pod status at 364 and returns the health state at 366. Towards this end, a reply with HTTP status code 200 may be sent as soon as an endpoint for the new pod exists on the node; this does not reflect the actual health of the pod.

While a single health check is shown in FIG. 4, multiple health checks may be performed. For example, health checks may continue to be performed until a configured threshold number of consecutive successful health checks is reached (e.g., three iterations performed at an interval of 30 seconds, or another number of iterations at intervals with a different predefined duration). After the configured threshold number of consecutive successful health checks is reached, the status of the target in the load balancer target group changes to healthy (e.g., at 370) and traffic is now also sent to this new target. Notably, a new replica will not handle traffic immediately after the pod begins running; rather, it also needs to become ready and pass the threshold of successful health checks.

The pod disruption budget (PDB) ensures a sequential replacement of pods. In particular, the pod disruption budget defines a threshold of how many pods within a replica set may be unavailable at a given time. The threshold can be defined as a minimum absolute number or relative percentage of pods that need to be available or a maximum number/percentage of pods that may be unavailable at a time. For example, if a replica set of 3 pods is to be replaced with another replica set, the PDB prevents all pods from being stopped and replaced at once. The PDB thus defines whether an operation in a replica set is handled for the pods one-by-one or for multiple pods at a time. However, the current deployment terminates old replicas immediately once the replacement is up and running. This can become a problem, especially in clusters that have only one replica. Due to the threshold and interval for successful consecutive health checks from the load balancer, the new target might not be considered as healthy while the replica behind the old target is already terminating. As the health status of the terminating target also will not change immediately, the target group now includes a healthy target which is actually terminating and an unhealthy target which is actually running. Accordingly, in this circumstance, the load balancer would send traffic to a terminating pod and not send traffic to a pod that is actually running.

To give the new target the time to become healthy before the old target starts terminating, the termination of the old target must be delayed. In KUBERNETES, this can be achieved by adding a field named minReadySeconds to the deployment specification, which dictates a minimum number of seconds that should elapse before a new replica is considered ready. Thus, the presence of this field in the deployment specification causes the new replica to wait for the defined number of seconds after the new replica is reported as ready before the termination request is sent to the old replica. Experiments have shown that 120 seconds is a good value for testing when the thresholds for health checks are set to three iterations at an interval of 30 seconds maximum. However, for production usage, a new node and pod may not always become ready within 120 seconds; accordingly, a value higher than 120 seconds may be chosen. Extending the value of the minReadySeconds fields to be greater than 120 seconds may not have a significant impact in production usage, as the rolling update process will take much longer to complete (e.g., it will take much longer for the old pods to terminate).

Accordingly, as shown, the replica set controller 308 instructs the API server 304 to wait for the number of seconds defined in the minReadySeconds field at 368, and then instructs the API server 304 to terminate the corresponding pod from the old replica set at 372. At 374, the replica set controller 308 instructs the API server 304 to set the status of the corresponding pod from the old replica set to terminating and sets a deletion time stamp.

To avoid terminating established long-living connections immediately and instead keep them running for a defined period of time, the termination process during replica replacement is modified in the techniques herein relative to typical KUBERNETES rolling updates procedures. Without such changes, old pods would receive the deletion request from the running deployment update after the minReadySeconds duration of the new pod has passed. In particular, the unmodified procedure includes sending the defined stop signal to the old pod, waiting for a default grace period of 30 seconds for the termination of the old pod to finish, and terminating the old pod forcefully after 30 seconds if that has not happened. Practically, this means that after the readiness probe of the new pod succeeds, the old pod will be terminated after 30 seconds at the latest.

Accordingly, in order to control the duration after which old connections are forcefully terminated, the default grace period can be adjusted. Towards this end, the value of a grace period field in the deployment specification can be adjusted to an appropriate value; in KUBERNETES, the grace period field is named terminationGracePeriodSeconds. In some examples, a value for the grace period field of approximately 24 hours (e.g., approximately 86,400 seconds) can be used. With a modified grace period value of 24 hours, long-living connections will persist for a maximum of 24 hours after the deployment update before they are terminated forcefully. This should give clients and applications enough time to finish their workloads, end the connections, and replace them with new connections. In other examples, the grace period may have a longer duration such as multiple days (e.g., seven days).

Accordingly, after the replica set controller 308 sets the pod status to terminating, this status change is detected by the kubelet 320 as it watches for pods to be deleted at 376. In response to detecting that the old pod has a status of terminating, the kubelet 320 sends a request to the CRI 322 to run a PreStop hook at 378. In KUBERNETES, the PreStop Hook is a lifecycle hook that serves as a mechanism for implementing graceful shutdown of a container. The kubelet 320 then sends a request to the API server 304 to update the pod health status at 380. Next, the kubelet 320 instructs the CRI 322 to wait for the grace period at 382 and then stop the containers at 384. In the depicted example, the CRI 322 waits for the grace period before stopping the containers because the pod has one or more open connections.

However, in examples where the pod is not associated with any open connections, it can be deleted early and without waiting for the duration of the grace period. This can be achieved by sending a SIGUSR1 signal to the processes in the pod to terminate the reverse proxy processes gracefully (i.e., such that the reverse proxy processes exit when they are no longer handling any connections). When all reverse proxy processes have exited, the pod will be deleted. In this case, the SIGUSR1 signal can be sent to the reverse proxy processes using a PreStop hook before the pod switches to the terminating status. The SIGUSR1 signal is a user-defined signal that can trigger custom behavior in applications.

Next, the kubelet 320 instructs the API server 304 to delete the pod object at 386, and the replica set controller 308 instructs the API server 304 to update the replica sets at 388. The cluster autoscaler 312 then watches the API server 304 for unused nodes at 390; upon detection of an unused node, the cluster autoscaler 312 instructs the cloud provider 316 to delete the corresponding VM at 392. The cluster autoscaler 312 then instructs the API server 304 to delete the unused node at 394. The load balancer controller 314 watches the API server 304 for nodes at 396; upon detection of the deletion of the node, the load balancer controller 314 instructs the cloud provider 316 to update the load balancer target group accordingly at 398. The process 300 can then be repeated for the next replica of the old replica set, and so on, until all replicas of the old replica set have been replaced with new replicas in accordance with the updated deployment.

It will be appreciated that during the rolling update, the replicas of a replica set are handled almost in parallel. For example, as soon as one new replica is up-and-running (after minReadySeconds), the stop signal is sent to its corresponding predecessor and the next new replica is requested to be created. Thus, after a duration equal to n*minReadySeconds has elapsed, all new replicas are ‘up’ and handling new connections. The PDB is relevant in this context, which can be defined such that that the number of replicas serving incoming requests (old plus new replicas serving incoming requests) is equal to the original number of replicas +/−1 replica.

In some circumstances, the cluster autoscaler 312 may delete the underlying node for a new pod after approximately ten minutes because it considers the node as idle. This may occur due to configured requests in the pod specification being below a certain utilization threshold. To avoid this issue, an annotation can be added to the reverse proxy pod metadata to stop the cluster autoscaler 312 from evicting pods (e.g., the annotation “cluster-autoscaler.kubernetes.io/safe-to-evict”: “false” in KUBERNETES). Other possible approaches for addressing this issue include configuring a parameter named scaleDownUtilizationThreshold in the cluster autoscaler settings to adjust the utilization threshold, and/or increasing the requested resources.

Process 300 can also include additional steps which are not depicted in FIGS. 3-4 for the sake of brevity. For example, process 300 can include additional health checks, as well as steps for updating/removing endpoint slices and updating IP tables.

It will be appreciated that in process 300, all the pods are monitored, but action is taken only on a single pod currently being handled. In the end, all pods will be handled, but the change operations are handled individually on a single pod.

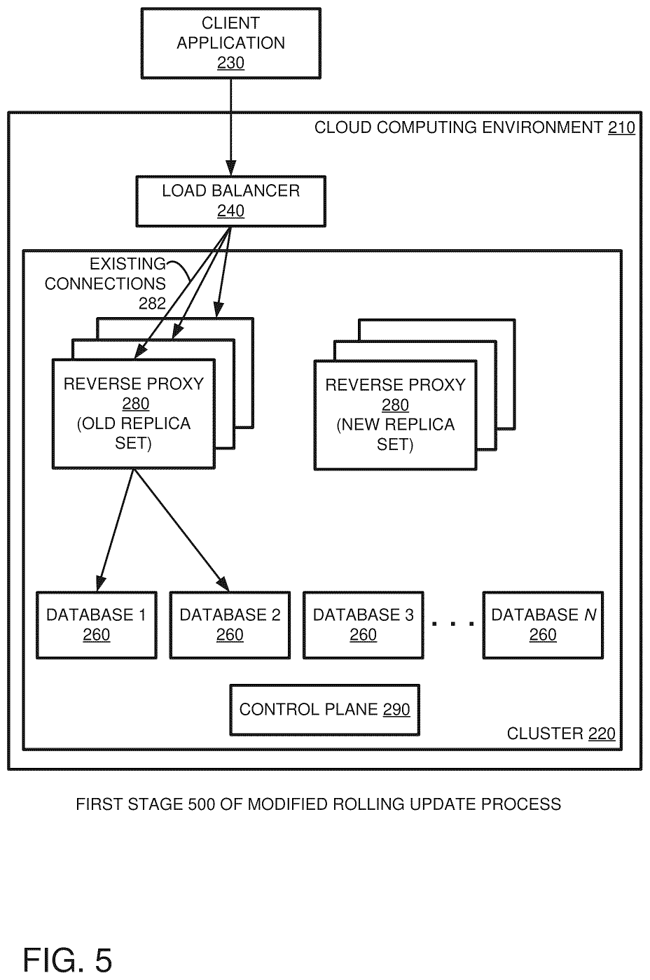

FIGS. 5-8 are block diagrams of the example system 200 of FIG. 2 during different stages of a modified rolling update process for updating the reverse proxy, such as process 300 of FIGS. 3-4. While certain components of system 200 are not depicted in FIGS. 5-8 for the sake of simplicity, it will be appreciated that the systems shown in FIG. 5-8 may include all the components of system 200 in practice, among other components. In the example, certain numbers of connections to certain databases are shown for ease of explanation; in practice, any number of connections to any number of different databases may be present.

FIG. 5 depicts the system 200 during a first stage 500 of a modified rolling update process in which the old replica set of reverse proxies and the new replica set of reverse proxies are deployed in parallel. In the example, an update to a deployment of the reverse proxy 280 has been initiated (e.g., to institute a software upgrade), and the replica set controller of the control plane 290 has created a new replica set for the reverse proxy 280 based on the updated deployment. At this stage, the existing connections 282 to databases 1 and 2 are still routed through the old replica set for the reverse proxy 280, as shown.

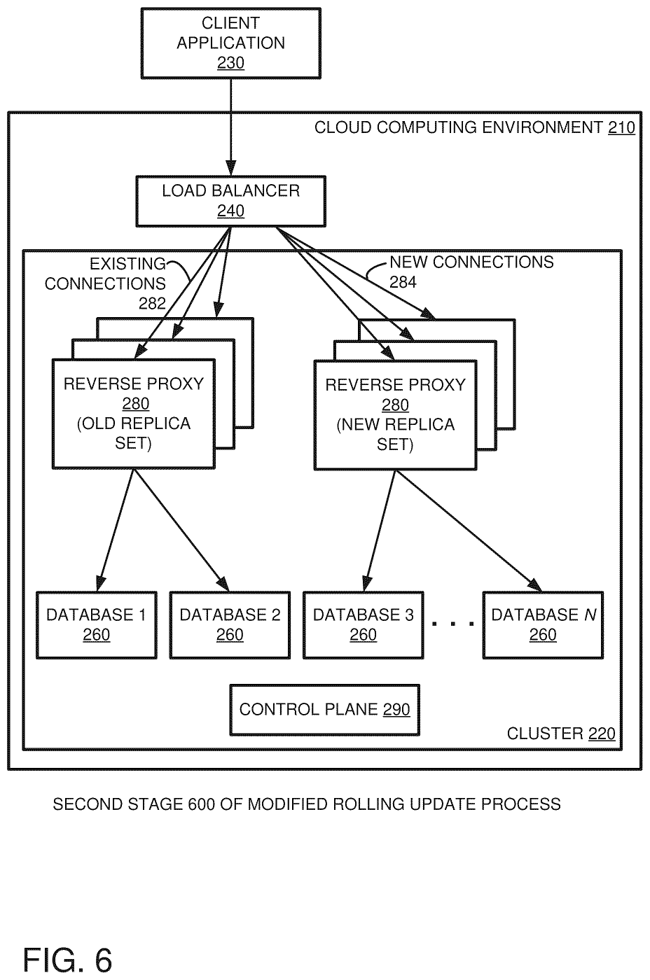

FIG. 6 depicts the system 200 during a second stage 600 of the modified rolling update process. After the updated deployment is up and running (e.g., within approximately two minutes), the new instances are set as targets within the load balancer 240. Accordingly, new connections 284 to the databases 260 are routed through the new replica set for the reverse proxy 280 (i.e., new connections 284 to databases 3 and N in the example). As shown, the existing connections 282 to databases 1 and 2 remain at this stage and are not modified.

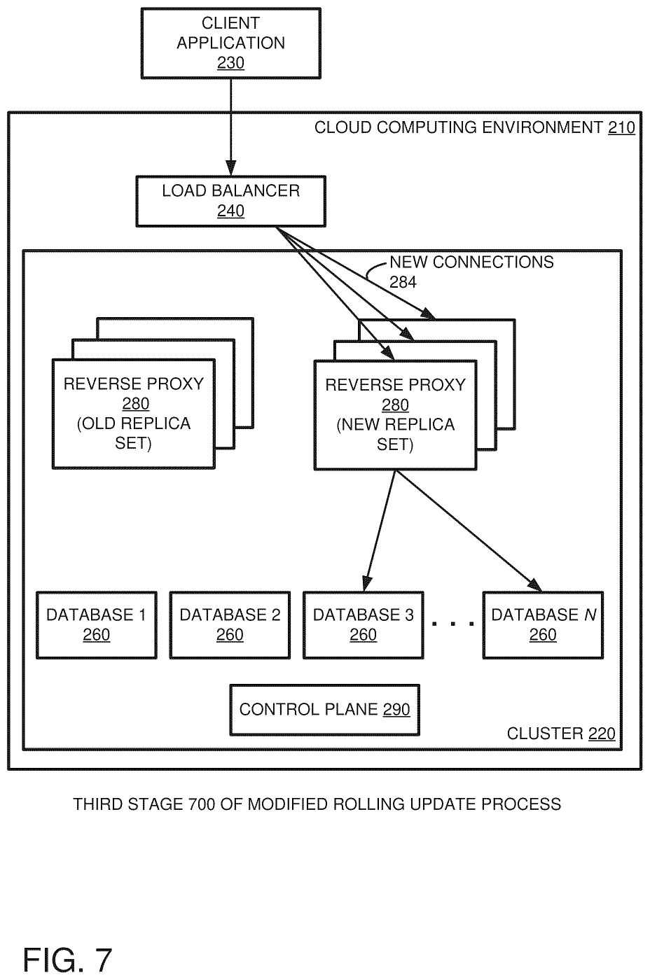

FIG. 7 depicts the system 200 during a third stage 700 of the modified rolling update process. At this stage, the existing connections 282 have terminated on the old replica set and thus are no longer shown. New connections 284 are routed to the new replica set only, and the old replica set becomes obsolete. However, the old replica set remains for the duration of the grace period, which may be 24 hours long or even multiple days long as described herein.

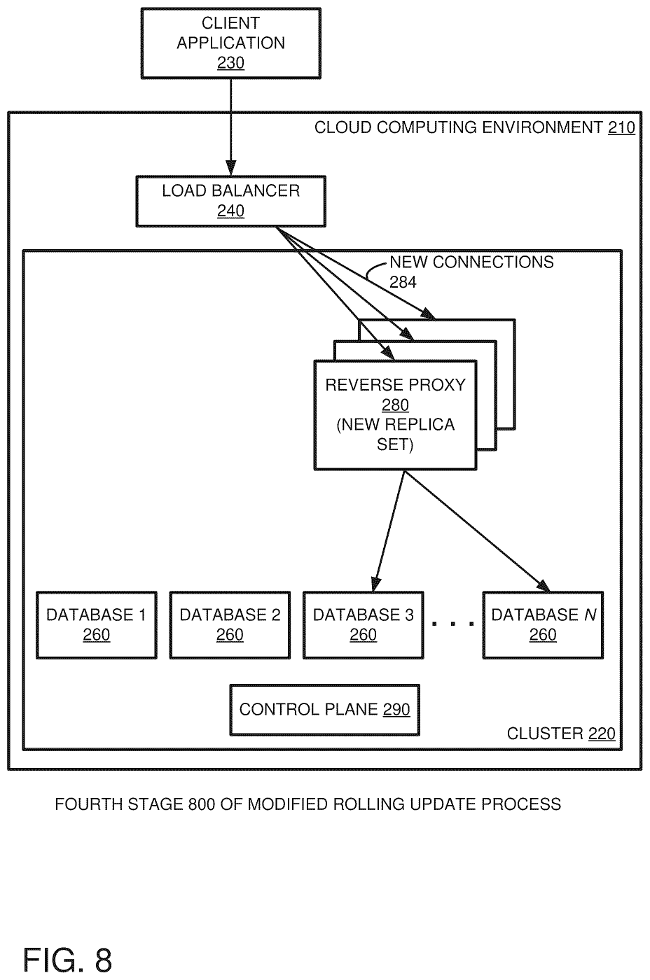

FIG. 8 depicts the system 200 during a fourth stage 800 of the modified rolling update process. At this stage, the grace period has ended and thus the old replica set for reverse proxy 280 has been removed. The system is now ready to receive another deployment update (e.g., another software upgrade).

While FIGS. 5-8 describe an example in which a deployment is updated for a reverse proxy, it will be appreciated that a similar process can be performed for other components of cluster 220 (e.g., other edge layer components of cluster 220, or non-edge-layer components such as databases 260).

### Example 5—Example Method of Updating Containers Via a Modified Rolling Update Procedure

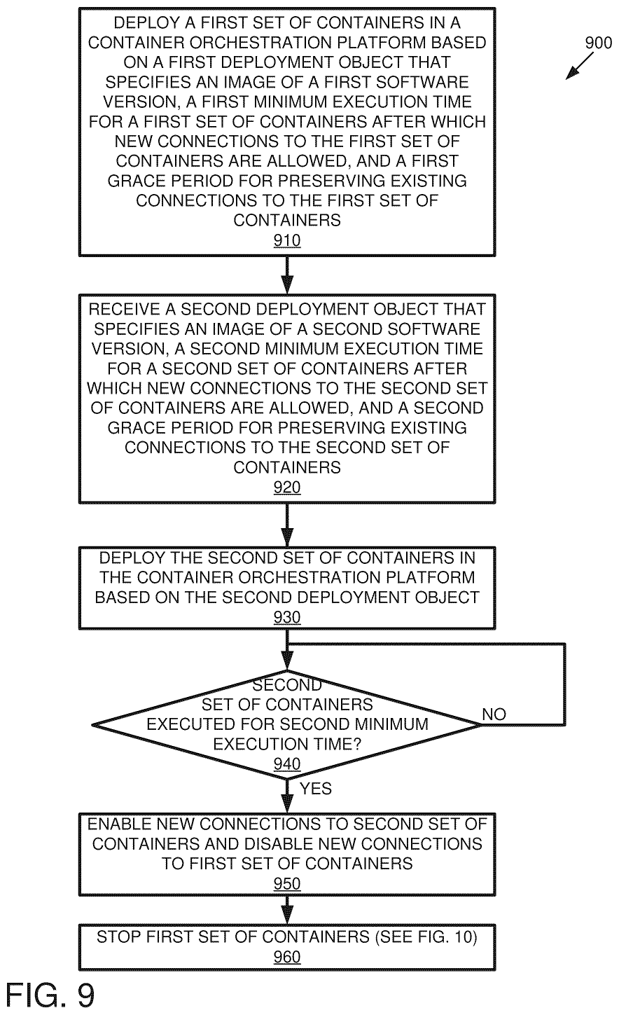

FIG. 9 is a flowchart of an example method 900 of updating containers using a modified rolling update procedure and can be performed, for example, by the system of FIG. 2. In particular, method 900 can be performed by a control plane of a container orchestration platform, such as control plane 290 of FIG. 2.

In the example, at 910, a first set of containers is deployed a container orchestration platform based on a first deployment object that specifies an image of a first software version, a first minimum execution time for a first set of containers after which new connections to the first set of containers are allowed (e.g., a first value of a minReadySeconds parameter), and a first grace period for preserving existing connections to the first set of containers (e.g., a first value of a terminationGracePeriodSeconds parameter). The existing connections to the first set of containers can refer to connections between a client application and a third set of containers deployed in the container orchestration platform (e.g., containers that function as database components of a cloud database) which are routed through the first set of containers. The new connections can refer to connections between the client application and the third set of containers which are routed through the first set of containers. The first software version can include software that provides the functionality of an edge layer component of a cloud database (e.g., reverse proxy software), or another type of software. The container orchestration platform can be KUBERNETES or another type of container orchestration platform.

The first minimum execution time specified in the first deployment object may be greater than a typical execution time specified in deployment objects. In some examples, the first minimum execution time has a value within a range of 60 seconds to 600 seconds. In practice, the first minimum execution time may be selected based on a threshold number of pod health checks and/or a predefined interval duration between pod health checks, as described herein. For example, if the threshold number is three and the interval duration is 30 seconds, a value of 120 seconds may be selected for the first minimum execution time.

The first grace period specified in the first deployment object may be greater than a typical grace period specified in deployment objects. In some examples, the first grace period has a value within a range of one day (e.g., 24 hours or 86400 seconds) to seven days. Grace periods with values within this range should provide adequate time for client applications to finish workloads associated with existing connections so that the connections can be replaced with new connections.

At 920, a second deployment object is received that specifies an image of a second software version. The second software version can be an updated version of the first software version, for example. The second deployment object further specifies a second minimum execution time for a second set of containers after which new connections to the second set of containers are allowed (e.g., a second value of the minReadySeconds parameter) and a second grace period for preserving existing connections to the second set of containers (e.g., a second value of the terminationGracePeriodSeconds parameter). The existing connections can refer to connections between the client application and the third set of containers deployed in the container orchestration platform (e.g., containers that function as database components of a cloud database) which are routed through the second set of containers. Similarly, the new connections can refer to connections between the client application and the third set of containers which are routed through the second set of containers.

In some examples, the values of certain parameters of the first and second deployment objects may be the same. For example, the first minimum execution time and the second minimum execution time may have the same value, and/or the first grace period and the second grace period may have the same value. In other examples, the values of parameters such as the minimum execution time and the grace period may be different.

In some examples, the first and second deployment objects are received from a software development team. For example, when a new version of a software component (e.g., HAProxy) becomes available, a software development team may decide to activate the new version in the production landscapes. This can be done by sending a new deployment object to the container orchestration platform (e.g., to an API server such as API server 291 of FIG. 2).

At 930, the second set of containers are deployed in the container orchestration platform based on the second deployment object (e.g., based on information specified in the deployment object including the image of the second software version, the second minimum execution time, and the second grace period). At 940, the method includes determining whether the second set of containers have executed for the second minimum execution time specified in the second deployment object. If the answer is NO, the method returns to 940 and waits for the second minimum execution time to elapse.

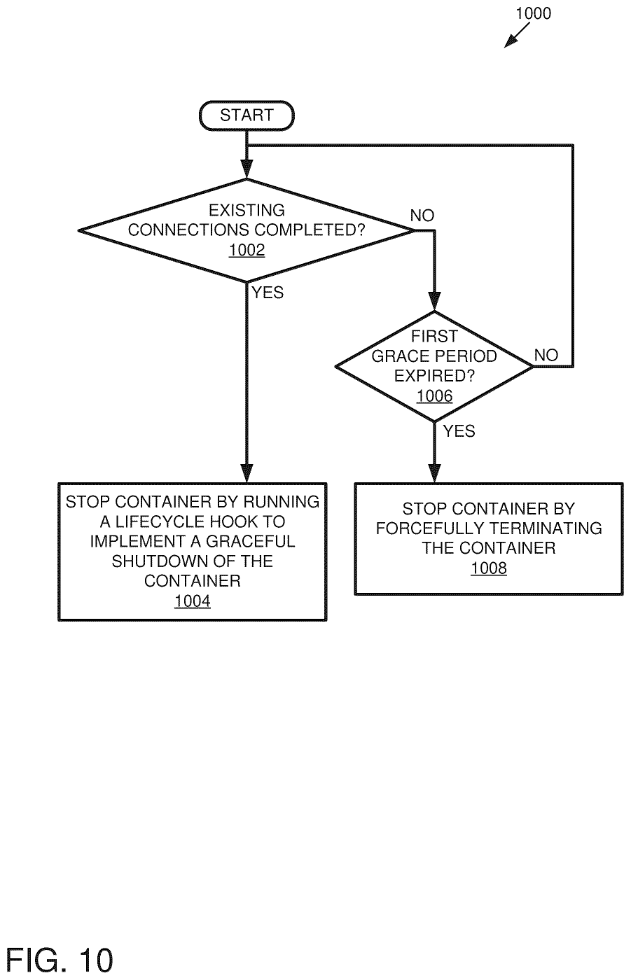

Otherwise, if the answer at 940 is YES, the method proceeds to 950 to enable new connections to the second set of containers and disable new connections to the first set of containers. Accordingly, at this stage, existing connections to the first set of containers may remain, but new connections are routed through the second set of containers rather than the first set of containers. Next, at 960, the first set of containers are stopped in accordance with the method shown in FIG. 10. In particular, the method of FIG. 10 can be performed for each container of the first set of containers (e.g., in parallel, or sequentially). As described below with reference to FIG. 10, the first set of containers are stopped in accordance with a specific sequence of events to reduce potential disruption of existing long-lived connections.

The method 900 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a deployment object can be described as sending a deployment object depending on perspective.

### Example 6—Example Method of Stopping a Container During a Modified Rolling Update Procedure

FIG. 10 is a flowchart of an example method 1000 of stopping a container during a modified rolling update procedure and can be implemented in any of the examples herein (e.g., the system shown in FIG. 2), in conjunction with method 900 of FIG. 9. In particular, method 1000 can be performed at step 960 of method 900 for each container of the first set of containers, as described above, by a control plane of a container orchestration platform. For example, method 1000 may be performed in parallel for all the containers of the first set of containers.

At 1002, the method includes determining whether existing connections to the container have completed (e.g., whether all existing connections to the container have completed). If the answer at 1002 is YES, the method proceeds to 1004 to stop the container by running a lifecycle hook to implement a graceful shutdown of the container. In examples where the container orchestration platform is KUBERNETES, the lifecycle hook can be a PreStop hook, and running the PreStop hook can include sending a SIGUSR1 signal to the container being stopped.

Otherwise, if the answer at 1002 is NO, the method proceeds to 1006 to determine whether the first grace period for preserving existing connections to the first set of containers has expired (e.g., the first grace period specified in the first deployment object). If the answer at 1006 is NO, the method returns to 1002.

Otherwise, if the answer at 1006 is YES, the method proceeds to 1008 to stop the container by forcefully terminating the container. Once all containers of the first set of containers have been stopped, the method ends. At this stage, all connections are routed through the second set of containers (e.g., as shown in FIG. 8).

### Example 7—Example Integration into Cloud Databases

In any of the examples herein, the technologies can be integrated into software for cloud databases that employ container orchestration platforms. For example, cloud-based database services available from SAP SE, of Walldorf, Germany, such as SAP S/4 HANA Cloud, can incorporate the modified rolling update procedures described herein.

### Example 8—Example Implementations

Any of the following can be implemented.

Clause 1. A computer-implemented method comprising: deploying a first set of containers in a container orchestration platform based on a first deployment object that specifies an image of a first software version, wherein the first deployment object further specifies a grace period for preserving existing connections to the first set of containers; receiving a second deployment object that specifies an image of a second software version, wherein the second deployment object further specifies a minimum execution time for a second set of containers after which new connections to the second set of containers are allowed; deploying the second set of containers in the container orchestration platform based on the second deployment object; and after the second set of containers have executed for the minimum execution time: enabling new connections to the second set of containers; disabling new connections to the first set of containers; and for a given container of the first set of containers, stopping the given container responsive to the earlier of: completion of existing connections to the given container; and expiration of the grace period.

Clause 2. The method of Clause 1, wherein the first set of containers and the second set of containers function as components of an edge layer of a cloud database.

Clause 3. The method of Clause 2, wherein a third set of containers that function as database components of the cloud database are deployed in the container orchestration platform.

Clause 4. The method of Clause 3, wherein a given existing connection to the first set of containers comprises an existing connection between a client application and one of the containers of the third set of containers that is routed through the first set of containers, and wherein a given new connection to the second set of containers comprises a new connection between the client application and another one of the containers of the third set of containers that is routed through the second set of containers.

Clause 5. The method of Clause 4, wherein: the edge layer of the cloud database further comprises a load balancer, and the existing connections and the new connections are also routed through the load balancer.

Clause 6. The method of any one of Clauses 2-5, wherein the first software version comprises reverse proxy software, and wherein the second software version is an updated version of the first software version.

Clause 7. The method of Clause 6, wherein the reverse proxy software comprises high availability proxy software.

Clause 8. The method of any one of Clauses 1-7, wherein: for a given container of first set of containers, stopping the given container responsive to completion of existing connections to the given container comprises, with the container orchestration platform, running a lifecycle hook to implement a graceful shutdown of the given container.

Clause 9. The method of Clause 8, wherein: the container orchestration platform is KUBERNETES, the lifecycle hook is a PreStop hook, and running the PreStop hook to implement the graceful shutdown of the given container comprises sending a SIGUSR1 signal to the given container.

Clause 10. The method of any one of Clauses 1-9, wherein: for a given container of first set of containers, stopping the given container responsive to expiration of the grace period comprises, with the container orchestration platform, forcefully terminating the given container.

Clause 11. The method of any one of Clauses 1-10, wherein the container orchestration platform is KUBERNETES.

Clause 12. The method of any one of Clauses 1-11, wherein the minimum execution time has a value within a range of 60 seconds to 600 seconds.

Clause 13. The method of any one of Clauses 1-12, wherein: deploying the second set of containers in the container orchestration platform comprises: creating one or more pods; performing a threshold number of health checks on the one or more pods at intervals having a predefined duration to determine whether a health status of the one or more pods is healthy or unhealthy; and responsive to the health status of the one or more pods being healthy, running the second set of containers within the one or more pods.

Clause 14. The method of Clause 13, wherein a value of the minimum execution time is selected based on the threshold number and the predefined duration.

Clause 15. The method of any one of Clauses 1-14, wherein the grace period has a value within a range of one day to seven days.

Clause 16. The method of any one of Clauses 1-15, wherein new connections to the second set of containers are initially disabled upon deployment of the second set of containers.

Clause 17. A computing system comprising: at least one hardware processor; at least one memory coupled to the at least one hardware processor; and one or more non-transitory computer-readable media having stored therein computer-executable instructions that, when executed by the computing system, cause the computing system to perform: deploying a first set of containers in a container orchestration platform based on a first deployment object that specifies an image of edge layer software for a cloud database, wherein the first deployment object further specifies a grace period for preserving existing cloud database connections to the first set of containers; receiving a second deployment object that specifies an image of an updated version of the edge layer software, wherein the second deployment object further specifies a minimum execution time for a second set of containers after which new cloud database connections to the second set of containers are allowed; deploying the second set of containers in the container orchestration platform based on the second deployment object; and after the second set of containers have executed for the minimum execution time: enabling new cloud database connections to the second set of containers; disabling new cloud database connections to the first set of containers; and for a given container of first set of containers, stopping the given container responsive to the earlier of: completion of existing cloud database connections to the given container; and expiration of the grace period.

Clause 18. The system of Clause 17, wherein: the first set of containers and the second set of containers function as components of an edge layer of the cloud database, and the edge layer of the cloud database further comprises a load balancer.

Clause 19. The system of Clause 18, wherein: a third set of containers that function as database components of the cloud database are also deployed in the container orchestration platform, a given existing connection to the first set of containers comprises an existing connection between a client application and one of the containers of the third set of containers that is routed through the first set of containers, and a given new connection to the second set of containers comprises a new connection between the client application and another one of the containers of the third set of containers that is routed through the second set of containers.

Clause 20. One or more non-transitory computer-readable media comprising computer-executable instructions that, when executed by a computing system, cause the computing system to perform operations comprising: deploying a first set of containers via KUBERNETES based on a first deployment object that specifies an image of reverse proxy software for a cloud database, wherein the first deployment object further specifies a grace period for preserving existing cloud database connections to the first set of containers; receiving a second deployment object that specifies an image of an updated version of the reverse proxy software, wherein the second deployment object further specifies a minimum execution time for a second set of containers after which new cloud database connections to the second set of containers are allowed; deploying the second set of containers via KUBERNETES based on the second deployment object, wherein new cloud database connections to the second set of containers are initially disabled after deployment of the second set of containers; and after the second set of containers have executed for the minimum execution time: enabling new cloud database connections to the second set of containers; disabling new cloud database connections to the first set of containers; and for a given container of first set of containers, stopping the given container responsive to the earlier of: completion of existing cloud database connections to the given container; and expiration of the grace period.

### Example 9—Example Advantages

A number of advantages can be achieved via the technologies described herein. In general, because the modified rolling update procedure can reduce downtime of a cloud database to a level near zero, necessary updates to edge layer components can be made with minimal disruption to cloud database operations. As a result, the technologies can avoid the unnecessary processing cost and time delays often associated with edge layer maintenance in a cloud database (e.g., due to interruption of long-lived database connections).

Towards this end, advantages can be achieved by fine-tuning values of selected parameters in deployment objects for containers deployed in a container orchestration platform. For example, the value of a minimum execution time parameter specified in the deployment object for a set of containers can be selected with the goal of ensuring that newly deployed containers are not made available for new connections until they are actually ready to accept new connections (e.g., until the status of the associated target node is healthy). To achieve this, a longer than typical value may be selected for the minimum execution time parameter (e.g., 120 seconds).

Further advantages can be achieved by selecting the value of the minimum execution time parameter based on values of parameters associated with pod health checks. For example, a threshold number of health checks may be performed on pods that run containers, at intervals having a predefined duration. An unexpected synergy may be achieved by selecting the value of the minimum execution time parameter based on the threshold number of health checks and the predefined duration of the health check intervals (e.g., as it is likely a new container will be ready for connections once the associated pod is healthy).

As another example, the value of a grace period parameter specified in the deployment object for a set of containers can be selected with the goal of preserving existing connections as long as is feasible (e.g., for one day or even multiple days). In this way, standard maintenance procedures in a container orchestration platform can be adapted to perform better in the context of a cloud database in which relatively long-lived connections are often used.

### Example 10—Example Computing Systems

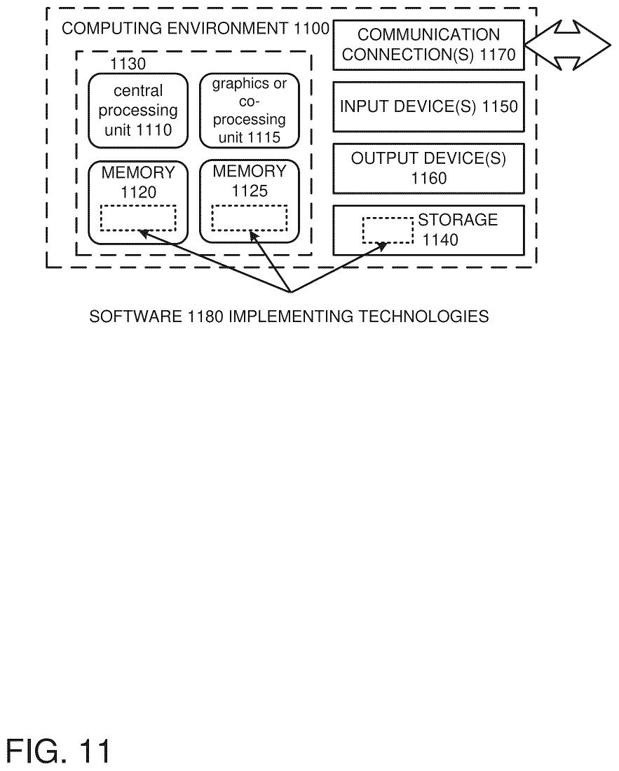

FIG. 11 depicts an example of a suitable computing system 1100 in which the described innovations can be implemented. The computing system 1100 is not intended to suggest any limitation as to scope of use or functionality of the present disclosure, as the innovations can be implemented in diverse computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 can be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 can have additional features. For example, the computing system 1100 includes storage 1140, one or more input devices 1150, one or more output devices 1160, and one or more communication connections 1170, including input devices, output devices, and communication connections for interacting with a user. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 can be removable or non-removable, and includes magnetic disks, magnetic tapes or cassettes, CD-ROMs, DVDs, or any other medium which can be used to store information in a non-transitory way and which can be accessed within the computing system 1100. The storage 1140 stores instructions for the software 1180 implementing one or more innovations described herein.

The input device(s) 1150 can be an input device such as a keyboard, mouse, pen, or trackball, a voice input device, a scanning device, touch device (e.g., touchpad, display, or the like) or another device that provides input to the computing system 1100. The output device(s) 1160 can be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 11—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 12—Example Cloud Computing Environment

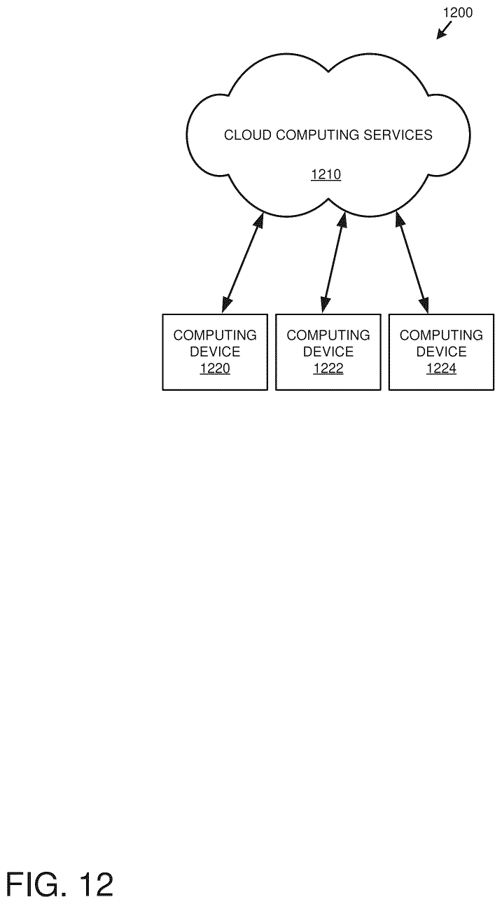

FIG. 12 depicts an example cloud computing environment 1200 in which the described technologies can be implemented, including, e.g., the system 200 of FIG. 2 and other systems herein. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operations (e.g., data processing, data storage, and the like).

In practice, cloud-based, on-premises-based, or hybrid scenarios can be supported.

### Example 13—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 14—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
deploying a first set of containers in a container orchestration platform based on a first deployment object that specifies an image of a first software version, wherein the first deployment object further specifies a grace period for preserving existing connections to the first set of containers;
receiving a second deployment object that specifies an image of a second software version, wherein the second deployment object further specifies a minimum execution time for a second set of containers after which new connections to the second set of containers are allowed;
deploying the second set of containers in the container orchestration platform based on the second deployment object; and
after the second set of containers have executed for the minimum execution time:
enabling new connections to the second set of containers;
disabling new connections to the first set of containers; and
for a given container of the first set of containers, stopping the given container responsive to the earlier of:
completion of existing connections to the given container; and
expiration of the grace period.

2. The method of claim 1, wherein the first set of containers and the second set of containers function as components of an edge layer of a cloud database.

3. The method of claim 2, wherein a third set of containers that function as database components of the cloud database are deployed in the container orchestration platform.

4. The method of claim 3, wherein a given existing connection to the first set of containers comprises an existing connection between a client application and one of the containers of the third set of containers that is routed through the first set of containers, and wherein a given new connection to the second set of containers comprises a new connection between the client application and another one of the containers of the third set of containers that is routed through the second set of containers.

5. The method of claim 4, wherein:
the edge layer of the cloud database further comprises a load balancer, and
the existing connections and the new connections are also routed through the load balancer.

6. The method of claim 2, wherein the first software version comprises reverse proxy software, and wherein the second software version is an updated version of the first software version.

7. The method of claim 6, wherein the reverse proxy software comprises high availability proxy software.

8. The method of claim 1, wherein:
for a given container of first set of containers, stopping the given container responsive to completion of existing connections to the given container comprises, with the container orchestration platform, running a lifecycle hook to implement a graceful shutdown of the given container.

9. The method of claim 8, wherein:
the container orchestration platform is KUBERNETES,
the lifecycle hook is a PreStop hook, and
running the PreStop hook to implement the graceful shutdown of the given container comprises sending a SIGUSR1 signal to the given container.

10. The method of claim 1, wherein:
for a given container of first set of containers, stopping the given container responsive to expiration of the grace period comprises, with the container orchestration platform, forcefully terminating the given container.

11. The method of claim 1, wherein the container orchestration platform is KUBERNETES.

12. The method of claim 1, wherein the minimum execution time has a value within a range of 60 seconds to 600 seconds.

13. The method of claim 1, wherein:
deploying the second set of containers in the container orchestration platform comprises:
creating one or more pods;
performing a threshold number of health checks on the one or more pods at intervals having a predefined duration to determine whether a health status of the one or more pods is healthy or unhealthy; and
responsive to the health status of the one or more pods being healthy, running the second set of containers within the one or more pods.

14. The method of claim 13, wherein a value of the minimum execution time is selected based on the threshold number and the predefined duration.

15. The method of claim 1, wherein the grace period has a value within a range of one day to seven days.

16. The method of claim 1, wherein new connections to the second set of containers are initially disabled upon deployment of the second set of containers.

17. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
deploying a first set of containers in a container orchestration platform based on a first deployment object that specifies an image of edge layer software for a cloud database, wherein the first deployment object further specifies a grace period for preserving existing cloud database connections to the first set of containers;
receiving a second deployment object that specifies an image of an updated version of the edge layer software, wherein the second deployment object further specifies a minimum execution time for a second set of containers after which new cloud database connections to the second set of containers are allowed;
deploying the second set of containers in the container orchestration platform based on the second deployment object; and
after the second set of containers have executed for the minimum execution time:
enabling new cloud database connections to the second set of containers;
disabling new cloud database connections to the first set of containers; and
for a given container of first set of containers, stopping the given container responsive to the earlier of:
completion of existing cloud database connections to the given container; and
expiration of the grace period.

18. The system of claim 17, wherein:
the first set of containers and the second set of containers function as components of an edge layer of the cloud database, and
the edge layer of the cloud database further comprises a load balancer.

19. The system of claim 18, wherein:
a third set of containers that function as database components of the cloud database are also deployed in the container orchestration platform,
a given existing connection to the first set of containers comprises an existing connection between a client application and one of the containers of the third set of containers that is routed through the first set of containers, and
a given new connection to the second set of containers comprises a new connection between the client application and another one of the containers of the third set of containers that is routed through the second set of containers.

20. One or more non-transitory computer-readable media comprising computer-executable instructions that, when executed by a computing system, cause the computing system to perform operations comprising:
deploying a first set of containers via KUBERNETES based on a first deployment object that specifies an image of reverse proxy software for a cloud database, wherein the first deployment object further specifies a grace period for preserving existing cloud database connections to the first set of containers;
receiving a second deployment object that specifies an image of an updated version of the reverse proxy software, wherein the second deployment object further specifies a minimum execution time for a second set of containers after which new cloud database connections to the second set of containers are allowed;
deploying the second set of containers via KUBERNETES based on the second deployment object, wherein new cloud database connections to the second set of containers are initially disabled after deployment of the second set of containers; and
after the second set of containers have executed for the minimum execution time:
enabling new cloud database connections to the second set of containers;
disabling new cloud database connections to the first set of containers; and
for a given container of first set of containers, stopping the given container responsive to the earlier of:
completion of existing cloud database connections to the given container; and
expiration of the grace period.
